(19) United States
(12) Patent Application Publication
(10) Pub. No.: US 2007/0006817 A1
(43) Pub. Date: Jan. 11, 2007

(54) ANIMAL STALL ASSEMBLY

(75) Inventor: Robert J. Komro, Durand, WI (US)

Correspondence Address: MICHAEL BEST & FRIEDRICH, LLP, 100 E WISCONSIN AVENUE, MILWAUKEE, WI, 53202, US

(73) Assignee: Komro Sales and Service, Inc., Durand, WI (US)

(21) Appl. No.: 11/383,050

(22) Filed: May 12, 2006

(51) Int. Cl. A01K 1/00

(52) U.S. Cl. 119/523

(57) ABSTRACT

A free stall divider for use in a barn having an animal rest area, a structural member near a forward portion of the rest area, and an alley near a rearward portion of the rest area. The free stall divider includes a divider member configured to be cantilever mounted to the structural member. The divider member is configured to extend from the structural member in the rearward direction, and the divider member at least partially defines a free stall.

### BACKGROUND

The present invention relates to a free stall divider for a free stall barn.

In a tie stall or stanchion barn, the barn includes stanchions that are designed to restrain animals, such as cows, at a particular location so the animals can be milked, fed, etc. Typically, the stanchion restrains the head of the animal to generally prevent the animal from moving side to side or forwardly and rearwardly while giving the animal the freedom to lie and stand. Stanchion barns can include movable dividers between the stanchions that are lowered after the animal enters the stall and raised after the animal exits the stall.

Alternatively, the barn can include free stalls, which do not include stanchions. Free stalls define resting areas for the animals typically while the animals are not being fed or milked. Generally, a barn that includes free stalls has an alley along which the animals can move at their own volition to other parts of the barn, such as feeding stations or milking parlors.

### SUMMARY

In one embodiment, the invention provides a free stall divider for use in a barn having an animal rest area, a structural member near a forward portion of the rest area, and an alley near a rearward portion of the rest area. The free stall divider includes a divider member configured to be cantilever mounted to the structural member. The divider member is configured to extend from the structural member in the rearward direction, and the divider member at least partially defines a free stall.

In another embodiment, the invention provides a barn that includes an animal rest area, a structural member, an alley, and a divider member. The animal rest area includes a forward portion and a rearward portion. The alley is near the rearward portion of the rest area, and the structural member is near the forward portion of the rest area. The divider member is cantilever mounted to the structural member, and the divider member extends from the structural member in the rearward direction. The divider member at least partially defines a free stall.

In yet another embodiment the invention provides a method of assembling a free stall divider for use in a barn having an animal rest area, a structural member near a forward portion of the rest area, and an alley near a rearward portion of the rest area. The method includes providing a divider member, and mounting the divider member to the structural member such that the divider member is cantilevered from the structural member and extends in the rearward direction.

Other aspects of the invention will become apparent by consideration of the detailed description and accompanying drawings.

### BRIEF DESCRIPTION OF THE DRAWINGS

FIG. 1 is a perspective view of a plurality of free stalls according to one embodiment of the present invention.

FIG. 2 is a side view of the free stalls of FIG. 1.

FIG. 3 is a perspective view of a plurality of free stalls according to another embodiment of the present invention.

FIG. 4 is a side view of the free stalls of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

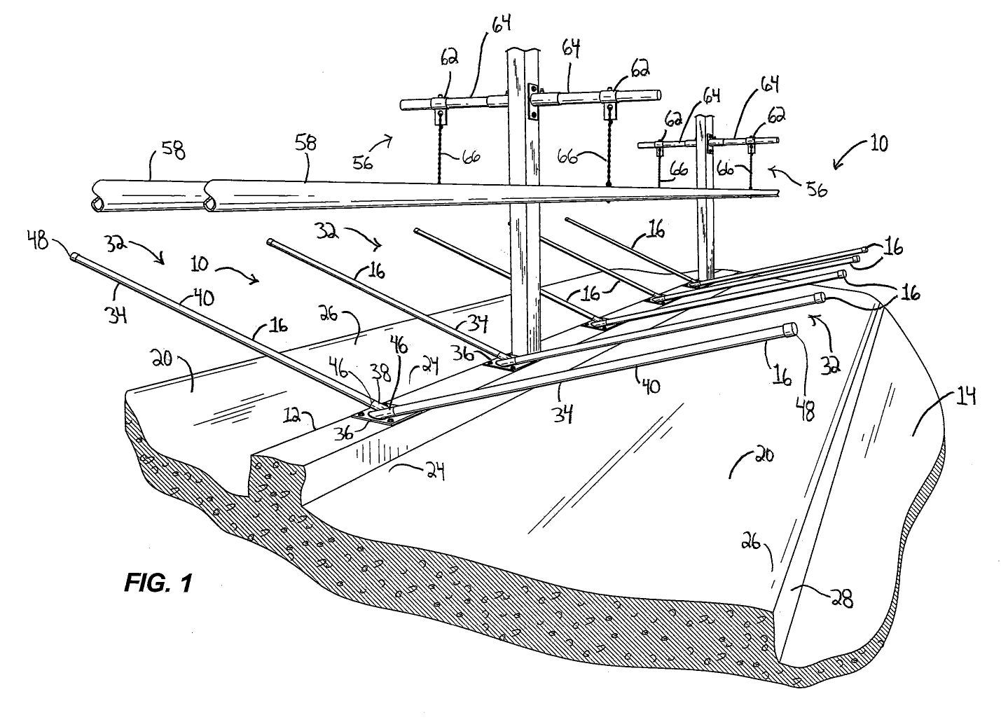

FIG. 1 illustrates a portion of a barn that provides shelter for animals, such as cows. The barn includes an animal rest area 10, structural member 12, an alley 14 and free stall dividers 16. In the illustrated construction of the barn, there are two adjacent rest areas 10 with the structural member 12 therebetween. In other constructions of the barn, one of the two adjacent rest areas 10 may be omitted.

The illustrated animal rest area 10 is partially defined by a floor 20, and the animal rest area 10 defines a forward portion 24 and a rearward portion 26. The illustrated structural member 12 is positioned near the forward portion 24 of the rest area 10, between floor areas 20, and is generally a raised curb above the floor areas 20. In other embodiments the structural member 12 could also include any suitable structural member of the barn, such as walls, columns, beams, other portions of the floor, and other members coupled to any one of these structural members.

The floor 20 of the illustrated animal rest area 10 is elevated above the alley 14 by a step 28. In other constructions, the floor 20 of the animal rest area 10 can be at the same elevation as the alley 14. Although only a portion of the alley 14 is illustrated, the alley 14 is generally wide enough to allow cows, other animals, machinery, etc. to travel through the alley 14.

The free stall dividers 16 define a plurality of free stalls 32 that are each defined by two adjacent free stall dividers 16. As is understood by one of skill in the art, free stalls generally do not include stanchions or other similar devices that retain the animal at generally one location, not allowing the animal to move out of the stall unless the stanchion is opened. Rather, free stalls allow the animal to move into and out of the stalls at their own volition.

Each of the free stall dividers 16 are generally the same. Therefore, only one of the free stall dividers 16 will be described in detail.

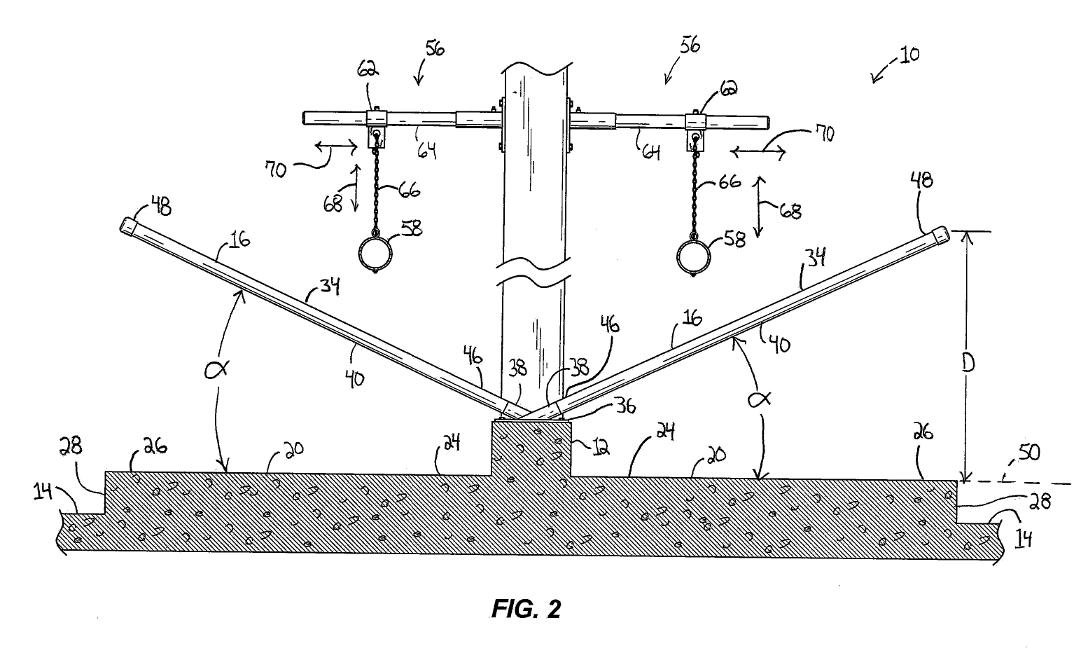

Referring to FIGS. 1 and 2, the free stall dividers 16 each include a divider member 34 and a base member 36. The illustrated base member 36 includes a plate and an aperture or socket 38. In one construction, the plate of the base member 36 is a 6 inch by 6 inch plate and the socket 38 is a 1¼ inch diameter socket. Of course other suitable dimensions of the plate and socket can be utilized. The base member 36 can be formed from any suitable material, such as steel, aluminum, composite, plastics, and the like.

With continued reference to FIGS. 1 and 2, the divider member 34 is a generally straight member. The illustrated divider member 34 includes an inner rod (not visible) generally covered with a removable sheath 40. In the illustrated construction, the inner rod is formed from a 1¼ inch solid fiberglass rod. Of course, other suitable sizes of the rod can be utilized, and while in the illustrated construction the inner rod of the divider member 34 is formed from a fiberglass rod, in other constructions the divider member 34 can be formed from any suitable material, such as steel, aluminum, plastic, composites, and the like. Furthermore, while the inner rod is a generally solid rod, in other constructions the inner rod can be replaced with tubing and the like.

The illustrated removable sheath 40 is formed from a schedule 40 polyvinyl chloride (PVC) pipe and an end cap. In other constructions the removable sheath 40 can be formed from other suitable materials, such as UV resistant hose and the like, and the sheath 40 can be any suitable size. The removable sheath 40 generally prevents contact between the fiberglass rod and the animals that utilize the free stall 32. The sheath 40 can also provide protection if the fiberglass rod breaks and/or splinters. Furthermore, while the illustrated divider member 34 includes the sheath 40 generally covering the inner rod, in other constructions the divider member may omit the sheath 40.

To assemble the free stall divider 16, the base member 36 is coupled to the structural member 12 of the barn. The illustrated base member 36 is coupled to the structural member 12 using a faster such as anchor bolts, anchor studs, and the like. In other constructions, the base member 36 can be wet set in fresh concrete. While the illustrated base member 36 is coupled to the ridge structural member 12, it should be understood that the base member 36 can be coupled to any other suitable structural member of the barn mentioned above, such as walls, columns, beams, other portions of the floor, and the like.

An end of the inner rod of the divider member 34 is inserted into the socket 38 of the base member 36 such that the divider member 34 includes a fixed end 46 and a free end 48. The fixed end 46 is coupled to the base member 36 such that the divider member 34 is cantilever mounted to the structural member 12 at the forward portion 24 of the rest area 10. The divider member 34 is cantilever mounted, which should be understood to include any suitable mounting configuration that includes one end of the divider member that is relatively fixed and a second end that is generally free and not connected to another support member such as the floor, alley, other structural members and the like. In one construction, the divider member 34 is coupled to the base member 36 using a fastener, such as a hex head bolt, a clamp, screw, and the like. In other constructions, the divider member 34 can be coupled to the base member 36 using any suitable connection, such as welding, brazing, etc.

The removable sheath 40 can be placed over the inner rod of the divider member 34. The divider member 34 is coupled to the structural member 12 such that the divider member 34 extends rearwardly toward the alley 14 and the free end 48 of the divider member 34 is near the alley 14. In the illustrated construction, the free end 48 of the divider member 34 extends to the step 28, and in other constructions the free end 48 may not extend all the way to the step 28. In one such construction the free end 48 of the divider member 34 is about 12 inches from the step 28.

In the construction illustrated in FIGS. 1 and 2, the divider member 34 extends upward at an angle α with respect to a horizontal plane 50. In the illustrated construction, the angle α is approximately 30 degrees. In other constructions, the angle α can be between about 25 degrees and about 35 degrees. In yet other constructions, the angle α can be between about 10 degrees to about 50 degrees. Furthermore, in other constructions the base member 36 can be angularly adjustable to facilitate positioning the divider member 34 at any suitable angle α with respect to the horizontal plane 50. Such constructions would allow adjustment of the angle α depending on the size of the animal that utilizes the free stall 32.

The angle α can vary depending on the height of the base member 36 with respect to the floor 20 and the type of animal that will use the free stall 32. In the illustrated construction, the angle α is such that the free end 48 is a distance D of approximately 36 inches above the floor 20 of the rest area 10. In other constructions, the free end 48 can be any suitable distance D above the floor 20.

The angled arrangement of the divider members 34 illustrated in FIGS. 1 and 2 has been found to facilitate properly aligning animals within the free stalls 32, especially cows. The angled arrangement, with the free end 48 the distance D above the floor 20, places the divider member 34 adjacent the widest part of the cow to properly align the cow within the free stali 32.

Utilizing the solid fiberglass inner rod for the divider member 34 has been found to facilitate flexibility of the divider member 34. Therefore, the divider member 34 can adequately flex without breaking if the divider member 34 is struck by the animal as the animal rises, moves side to side, etc. The flexible divider member 34 also allows relatively large animals to take space from adjacent free stalls. Therefore, the divider members 34, which are typically evenly spaced, can be designed for the average size animal, while still suitable for use by larger animals.

Furthermore, the flexible divider member 34 facilitates maintenance of the animal rest area 10. Bedding material is typically placed on the floor 20 of the rest area 10 using a tractor, skid-steer loader, and the like. If the tractor strikes the divider member 34 when placing or removing bedding material from the rest area 10, the divider member can flex without breaking. While the illustrated divider member 34 includes the solid fiberglass inner rod to facilitate flexibility, it should be understood that other suitable materials can be used to form the divider member 34.

The illustrated barn further includes an animal positioning assembly 56. The animal positioning assembly 56 includes a control rail 58 that is supported above the divider member 34. The control rail 58 is supported using brackets 62 and support rails 64. The control rail 58 is coupled to the brackets 62 using chains 66. The brackets 62 are slidably supported on the support rails 64. The support rails 64 are coupled to columns or other suitable structural members of the barn, such that the control rail 58 is generally normal to the divider members 34.

Referring to FIG. 2, the illustrated control rail 58 is adjustable in both the vertical and horizontal directions. The control rail 58 is adjustable in the directions indicated by the arrows 68 by adjusting the length of the chains 66. The control rail is adjustable in the directions indicated by the arrows 70 by sliding the brackets 62 along the support rails 64.

The control rail 58 facilitates positioning the animal within the free stall 32. The animal enters the free stall 32 from the alley 14 such that the animal's head is adjacent the forward portion 24 of the rest area 10. With the animal's head beneath the control rail 58, the neck of the animal will contact the control rail 58 to generally restrain the animal from moving forward in the free stall past a predetermined position. The illustrated control rail 58 is adjustable to achieve the desired predetermined position with different animals or different size animals. As is understood by one of skill in the art, it is desirable to restrain the animal from moving too far forward in the free stall 32 past the predetermined point in order to align the rear portion of the animal with the alley 14. Therefore, excrement from the animal will generally fall in the alley 14 and not in the rest area 10.

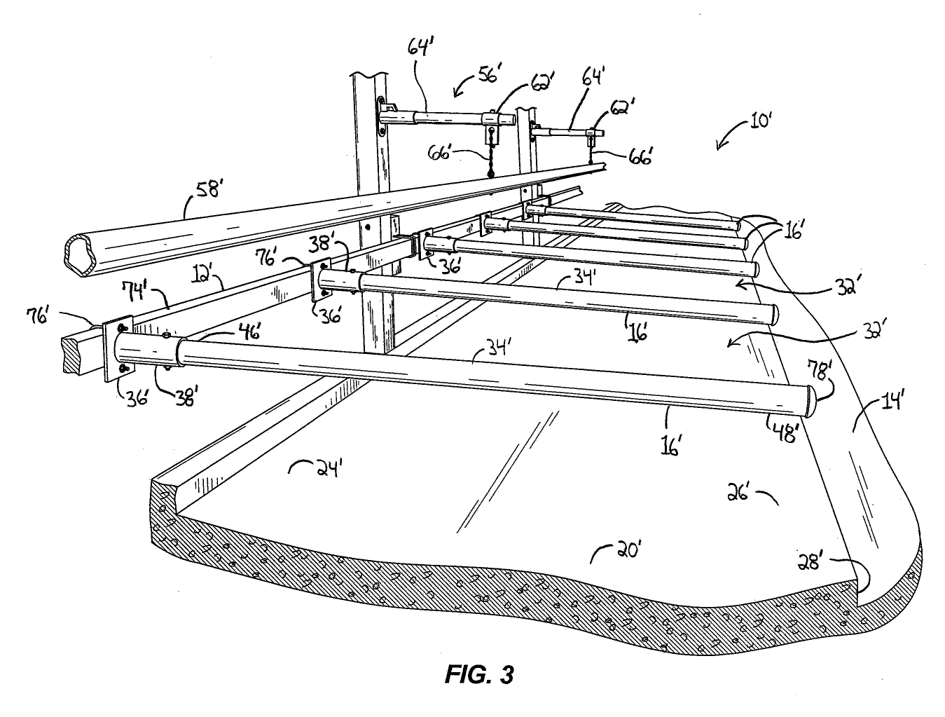

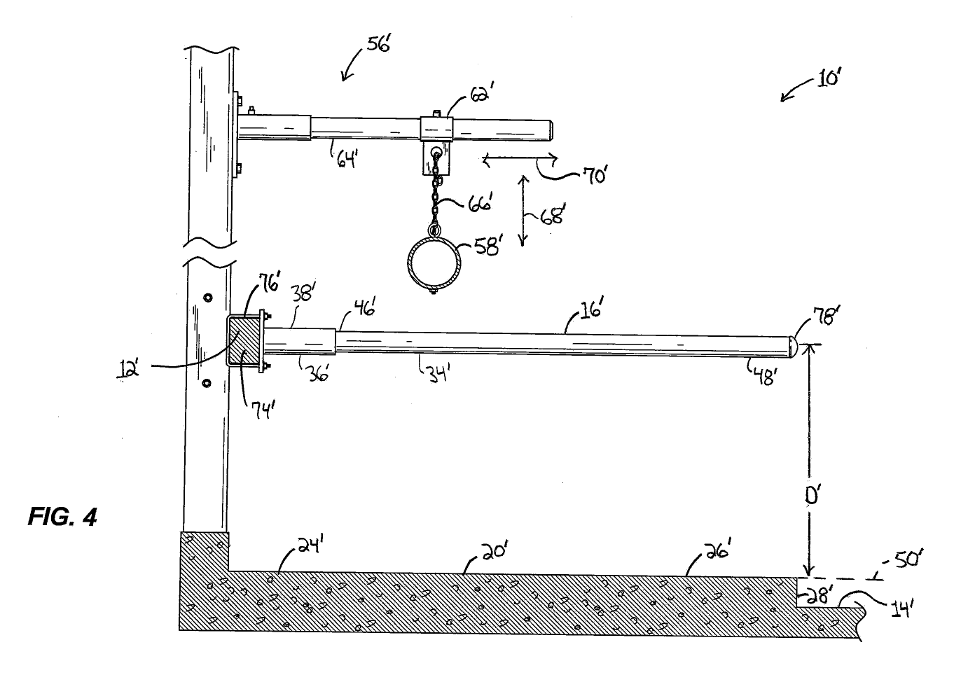

FIGS. 3 and 4 illustrate an alternative construction of the free stall divider 16 of FIGS. 1 and 2. The free stall divider 16′ of FIGS. 3 and 4 is generally the same as the free stall divider 16 of FIGS. 1 and 2 and like parts have been giving like reference numbers with the addition of a prime symbol. Because the free stall dividers 16′ of FIGS. 3 and 4 are generally the same as the free stall dividers 16 of FIGS. 1 and 2, only the differences will be discussed.

The free stall divider 16′ of FIGS. 3 and 4 includes the base member 36′ that couples the divider member 34′ to the structural member 12′ such that the divider member 34′ is generally parallel to the floor 20′ of the animal rest area 10′. In this embodiment, the structural member 12′ is utilized to support the base member 36′ and the divider member 34′, and the structural member 12′ includes a cross member 74′ that extends between columns of the barn. In other embodiments, the structural member 12′ can include any suitable structural member of the barn, such as walls, columns, beams, other portions of the floor, and the like. The illustrated base member 36′ is coupled to the cross member 74′ using a U-bolt fastener 76′. The U-bolt fastener 76′ allows the user to conveniently adjust the location of the base member 36′ along the cross member 74′, thereby allowing the user to adjust the distance between the divider members 34′. In other constructions other suitable fasteners, such as nails, screws, bolts and the like can be utilized to couple the base member 36′ to the cross member 74′. In yet other constructions, the base can be coupled to the cross member 74′ or the structural members 12′ by welding, brazing, etc.

With continued reference to FIGS. 3 and 4, the illustrated divider member 34′ is formed from a 3 inch diameter steel pipe that includes a cap 78′. In other constructions the divider member 34′ can be formed from other suitable materials such as aluminum, plastic, composites, and the like. In yet other constructions, the divider member 34′ can be formed from the fiberglass inner rod and removable sheath as described above with regard to FIGS. 1 and 2.

The free stall dividers 16, 16′ of FIGS. 1-4, which include the divider members 34, 34′, provide more freedom for the animals that utilize the free stalls 32, 32′ than conventional free stall dividers that utilize a looped-shaped pipe. It has been found that the divider members 34, 34′ allow the animals to side lunge and forward lunge when standing with minimal restriction by the divider members 34, 34′. Also, the straight and cantilever mounted design of the divider members 34, 34′ reduces the chance of the animal getting tangled or restrained by the divider member 34, 34′ when the animal stands. The angled design of the divider member 34 of FIGS. 1 and 2 reduces the chance that the animal will get caught underneath the divider member 34 when standing. However, the divider member 34′ of FIGS. 3 and 4 can be advantageous when more restraint is needed for the animals, such as with smaller cows, heifers, young stock, etc.

Various features and advantages of the invention are set forth in the following claims.

What is claimed is:

1. A free stall divider for use in a barn having an animal rest area, a structural member near a forward portion of the rest area, and an alley near a rearward portion of the rest area, the free stall divider comprising:
a divider member configured to be cantilever mounted to the structural member, the divider member configured to extend from the structural member in the rearward direction, the divider member at least partially defining a free stall.

2. The free stall divider of claim 1, wherein the divider member is generally straight.

3. The free stall divider of claim 1, wherein the divider member includes a tube.

4. The free stall divider of claim 1, wherein the divider member includes a fiberglass rod.

5. The free stall divider of claim 1, wherein the divider member includes a fixed end configured to be cantilever mounted to the structural member, and a free end opposite the fixed end.

6. The free stall divider of claim 5, further comprising a base member configured to be coupled to the structural member, the base member having an aperture that receives the fixed end of the divider member.

7. The free stall divider of claim 1, wherein the divider member is configured to extend in the rearward and upward direction.

8. The free stall divider of claim 1, wherein the divider member is configured to be cantilever mounted to the structural member to define an angle of between 10 to 50 degrees relative to a horizontal plane.

9. The free stall divider of claim 8, wherein the angle is between about 25 degrees to about 35 degrees relative to the horizontal plane.

10. A barn comprising:
an animal rest area including a forward portion and a rearward portion;
a structural member near the forward portion of the rest area;
an alley near the rearward portion of the rest area; and
a divider member cantilever mounted to the structural member, the divider member extends from the structural member in the rearward direction, the divider member at least partially defining a free stall.

11. The barn of claim 10, wherein the structural member includes at least one of a barn wall, a cross member that extends between barn support columns, and the floor of the rest area.

12. The barn of claim 10, further comprising an animal positioning member oriented generally normal to the divider member and movable in both a vertical direction and a horizontal direction.

13. The barn of claim 12, wherein the animal positioning member is not supported by the divider member.

14. The barn of claim 10, wherein the divider member is a first divider member, and wherein the barn further comprises a second divider member spaced from the first divider member to define the free stall in combination with the first divider member.

15. The barn of claim 10, wherein the barn includes a plurality of generally equally spaced divider members to define a plurality of free stalls.

16. The barn of claim 10, wherein the divider member includes a fixed end cantilever mounted to the structural member, and a free end opposite the fixed end.

17. The barn of claim 10, wherein the divider member is configured to extend in the rearward and upward direction.

18. The barn of claim 10, wherein the divider member is generally straight.

19. A method of assembling a free stall divider for use in a barn having an animal rest area, a structural member near a forward portion of the rest area, and an alley near a rearward portion of the rest area, the method comprising:
providing a divider member;
mounting the divider member to the structural member such that the divider member is cantilevered from the structural member and extends in the rearward direction.

20. The method of assembling a free stall divider of claim 19, wherein the divider member includes a fixed end and a free end, wherein mounting the divider member includes mounting the fixed end, the method further comprising allowing the free end to remain uncoupled and free to move.
